(19) United States
(12) Patent Application Publication
(10) Pub. No.: US 2009/0044158 A1
(43) Pub. Date: Feb. 12, 2009

(54) METHOD, AND EXTENSIONS, TO COUPLE SUBSTRATE EFFECTS AND COMPACT MODEL CIRCUIT SIMULATION FOR EFFICIENT SIMULATION OF SEMICONDUCTOR DEVICES AND CIRCUIT

(76) Inventor: Klas Olof Lilja, Pleasanton, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 12/101,808

(22) Filed: Apr. 11, 2008

Related U.S. Application Data
(60) Provisional application No. 60/923,484, filed on Apr. 14, 2007.

(51) Int. Cl. G06F 17/50

(52) U.S. Cl. 716/5

(57) ABSTRACT

This invention comprises a new method to couple simulation of electronics circuits (using compact models) with simulation of physical effects which require a PDE (partial differential equation) based simulation, for semiconductor MOSFET based devices and circuits. In particular the method can be used to capture high injection substrate effects such as single event transients (SET), latch-up, ESD, or thermal effects. Bipolar substrate effects are handled correctly and completely with this algorithm. The method extends the applicability of technology CAD (TCAD) to multiple devices.

B. Cross-Reference To Related Applications

This application claims the priority benefit of the provisional U.S. patent application Ser. No. 60/923,484.

### BACKGROUND OF THE INVENTION

A. Government Rights

This invention was made with Government support under (W31P4Q-06-C-0097) awarded by (DARPA). The Government has certain rights in the invention.

C. Field Of The Invention

This invention describes a new method to effectively couple compact model based circuit simulation, with physics based simulation. The method is particularly useful for MOSFET based circuits. It allows for simulation and analysis, at the circuit level, of various effects in the semiconductor substrate, which require a physics (PDE) based analysis.

The increasing importance of manufacturing and reliability issues in the design phase has increased the importance of physics based simulation capabilities, such as technology CAD (TCAD), which allow analysis, and some predictability, of complex issues in the interaction between design and manufacturing. However, TCAD simulation has a very limited capacity. Simulation of just one device can be in the range of minutes or even hours on a powerful workstation, and in order to study the relevant interaction issues between design and manufacturing, a minimum of several devices and their immediate surrounding (substrate, isolation, interconnect, etc.) needs to be simulated, and simulation times can be days or weeks. Many design issues cannot even be approached properly with TCAD, e.g., a lot of insight, and predictability, could be achieved if issues such as electrostatic discharge (ESD), radiation effects including single event transients (SET) and prompt dose, thermal effects, and substrate noise, could be approached with a physics based modeling at the circuit/layout abstraction level (beyond just one or two devices).

D. Prior Art

A well-known technique called mixed-mode device circuit simulation (or mixed-level simulation) couples the simulation of semiconductor device using partial differential equations (PDE's), technology CAD (TCAD), with the simulation of circuits using compact models. This technique has proven useful in the simulation and design of power semiconductor devices [1], where the device response depends strongly on the circuit environment, as well as in various other applications including simulation of single event transients (SET's) in semiconductor devices [2].

However, due to the immense computational effort associated with TCAD simulation, the applicability of prior art mixed-mode circuit simulation is limited.

The method of this invention is a new way to couple the simulation of effects, which require a fundamental physics modeling, with higher level circuit simulation. The method is much more efficient than prior art (˜10X-1000X), so that mixed-level circuit device simulation can be applied to a number of very interesting applications.

The efficiency advantage is achieved by letting the internal device operation be simulated using a compact circuit model, while still using PDE based simulation (TCAD) for the substrate. The computation speed and quality of PDE based simulation depends very strongly on the number of points and elements in the mesh used to discretize the PDE's. In prior art mixed-level simulation, the details of the circuit components must be resolved with mesh, and most of the mesh-points are used for this. In the new method, however, only the substrate and the interaction between devices needs to be resolved by the mesh.

Furthermore, in addition to the capacity advantage, the method discussed in this invention has another distinct advantage over traditional TCAD (including traditional mixed level device circuit simulation) when applied to circuit design problems. In order to get accurate results using regular TCAD, a considerable calibration effort must be undertaken. The calibration work requires detailed knowledge of the process and/or device structure (doping profiles, gate oxide and poly characteristics etc.), and usually involves weeks or months of parameter tuning. In contrast, the method we discuss here, makes use of the compact models for the MOSFET operation, and only the characteristics of the wells and substrate are needed as input. Little or no calibration is required to get accurate results.

### BRIEF SUMMARY OF THE INVENTION

This invention is a new method to couple simulation of electronics circuits (using compact models) with simulation of physical effects which require a PDE (partial differential equation) based simulation, for semiconductor MOSFET based devices and circuits. In particular the method can be used to capture high injection substrate effects such as single event transients (SET), latch-up, ESD, or thermal effects. Bipolar substrate effects are handled correctly and completely with this algorithm. The method extends the applicability of technology CAD (TCAD) beyond one or a few devices.

### DESCRIPTION OF DRAWINGS AND FIGURES

Drawing 1. Illustration of prior art versus this invention for an n-channel MOSFET. In prior art (to the left in the figure) the source, drain and channel area must be resolved with mesh for the numerical simulation of the device characteristics. The new method (to the right) couples the compact models of the circuit directly to the description of the carrier transport in the substrate via special boundary conditions at the region where the source and drain contacts are located. The bulk node of the compact model is also coupled directly to the substrate (via the electrostatic potential).

Drawing 2. Illustration of method and algorithm of this invention. The proposed simulation algorithm uses the netlist to simulate the individual devices using compact models, and uses the information about the layout to accurately include any substrate effects via the novel way to couple the substrate simulation and the circuit simulation.

Drawing 3. 2D device structure used to illustrate the accuracy and speed of the proposed new algorithm. The black lines parallel to the surface indicate where a charged particle passes through in the SET simulation shown in drawing 5.

Drawing 4. Forward conduction of the structure from drawing 3. The current at the pwell (acting as base in the parasitic npn) and the drain (acting as collector in the parasitic npn), as a function of the positive voltage applied to the pwell. The drain (acting as collector) is biased at 1.2V. The current of the model is very accurate (red) and with minor model calibration the difference between full TCAD and the model can be reduced practically to zero (green with symbols).This shows that the new method can accurately handle bipolar effects in the substrate.

Drawing 5. The current pulse, on the drain of the structure in drawing 3, generated by a single event charged particle of LET=5 [MeVcm2/mg] passing parallel to the surface (along the black lines in drawing 3). The current of the model is very accurate (red) and with minor model calibration the difference between full TCAD and the model can be reduced practically to zero (green with symbols).

### DESCRIPTION OF INVENTION AND HOW IT WORKS

This invention allows the details of the MOSFET circuit devices (their operation) to be simulated using standard compact circuit models, but lets the device interaction and various substrate effects be simulated using a detailed physics based model (solution of partial differential equations).

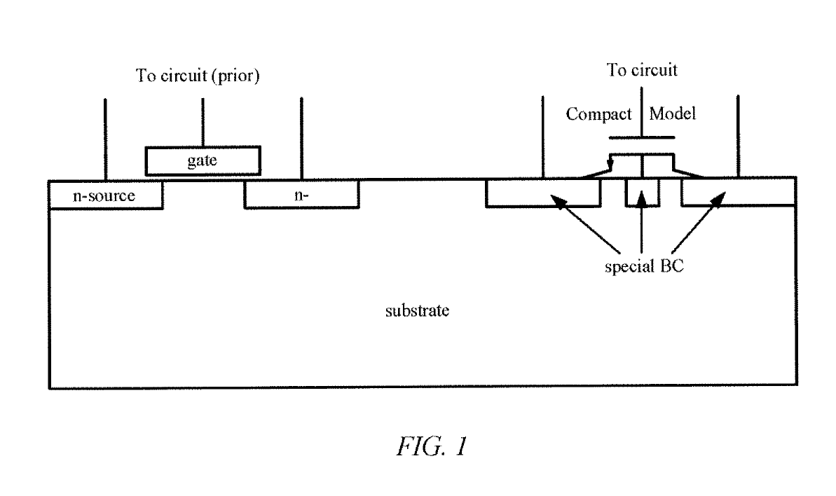

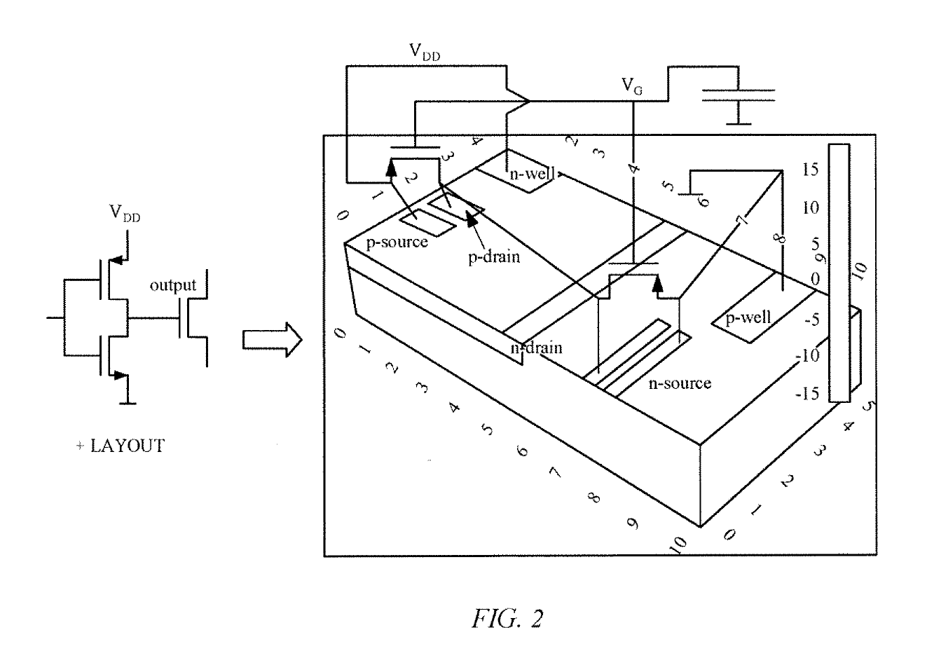

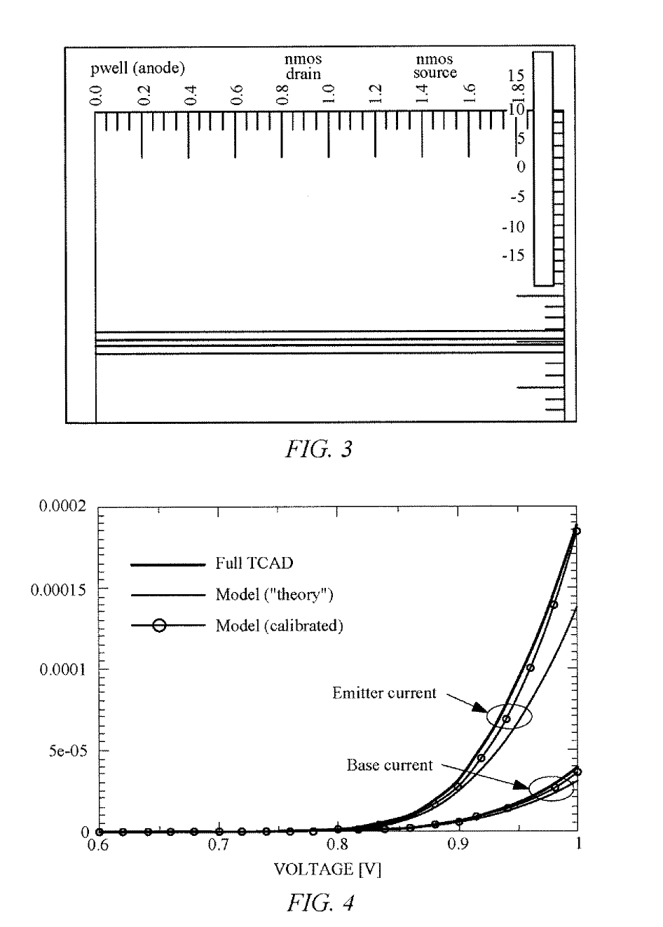

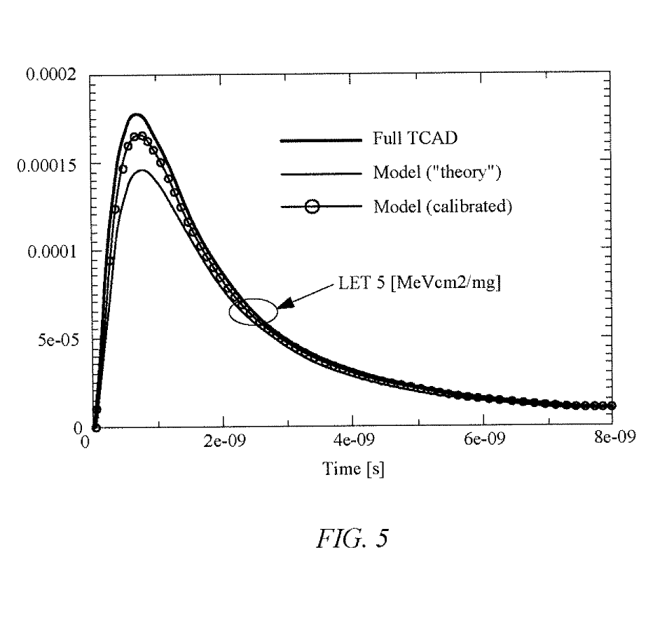

To achieve this we simulate the carrier transport in the substrate and wells with TCAD, using an appropriate standard model (e.g., drift-diffusion, thermodynamic, hydro-dynamic, density gradient) and develop new boundary conditions, which allow us to couple the circuit and the substrate at the junction of the source and drains (FIG. 1). The source, drain, and substrate nodes of the compact models are connected, at the place of the contact, to the substrate via special interface conditions. These interface conditions describe the capturing and injection of charge at the boundary. The basic form of these boundary conditions, for a pmos source contact, and for moderate injection conditions, read:

$$\begin{matrix}p = {p}_{0} {e}^{( \frac{{qV}_{SB}}{{k}_{B} T} )} , & ( 1 ) \\ {J}_{n} = q \frac{{D}_{n} {n}_{0}}{\sqrt{{τ}_{n} {D}_{n}}} ( {e}^{( \frac{{qV}_{SB}}{{k}_{B} T} )} - 1.0 ) , & ( 2 ) \\ n = {n}_{0} , & ( 3 )\end{matrix}$$

where, n, p are the electron and hole concentrations, with n0, p0 the equilibrium electron and hole concentrations at the n- (bulk-) side of the drain junction. VSB is voltage over the source junction, and Dn and tn are the minority carrier diffusivity and lifetime respectively. The total current (that goes into the circuit at this particular contact) is given by:

$${J}_{tot} = {J}_{n} + {J}_{p} + {C}_{j} \frac{d {V}_{SB}}{d t} , \qquad ( 4 )$$

where Jn, Jp are the total electron and hole currents entering the contact, and Cj is the (voltage dependent) junction capacitance. For an nmos the basic boundary conditions read:

$$\begin{matrix}n = {n}_{0} {e}^{( - \frac{{qV}_{SB}}{{k}_{B} T} )} , & ( 5 ) \\ {J}_{p} = q \frac{{D}_{p} {p}_{0}}{\sqrt{{τ}_{p} {D}_{p}}} ( {e}^{( \frac{{qV}_{SB}}{{k}_{B} T} )} - 1.0 ) , & ( 6 ) \\ p = {p}_{0} , & ( 7 )\end{matrix}$$

where Dp and tn are the minority carrier diffusivity and lifetime respectively. The total current (that goes into the circuit at this particular contact) is given by equation (4), as above.

The model above is valid for moderate injection conditions. At very high injection conditions (equations (3) and (7) not valid for the majority carrier concentration) the basic model can be extended in a manner analogous to standard bipolar compact models [3]. The extended model, also including recombination current, has the following form (for an nmos source or drain):

$$\begin{matrix}n = \frac{{n}_{0} {p}_{0} ( {N}_{D} - {N}_{A} )}{2 {n}_{i}^{2}} ( {( 1.0 + \frac{2 {n}_{i}^{2}}{{γ ( {N}_{D} - {N}_{A} )}^{2}} {e}^{( - \frac{{qV}_{SB}}{{k}_{B} T} )} )}^{γ} - 1.0 ) , & ( 8 ) \\ {J}_{p} = q {η}_{p} ( \frac{{n}_{0} {p}_{0} \vert {C}_{e} \vert}{2 {n}_{i}^{2}} ( {( 1.0 + \frac{2 {n}_{i}^{2}}{{γ ( {C}_{e} )}^{2}} {e}^{( - \frac{{qV}_{SB}}{{k}_{B} T} )} )}^{γ} - 1.0 ) - 1.0 ) + {β}_{p} ( {e}^{( - \frac{{qV}_{SB}}{2 {k}_{B} T} )} - 1.0 ) \sqrt{{V}_{B} - {V}_{SB}} , & ( 9 ) \\ p = n - ( {N}_{D} - {N}_{A} ) & ( 10 ) \\ {J}_{tot} = {J}_{n} + {J}_{p} + {C}_{j} \frac{d {V}_{SB}}{d t} , & ( 11 )\end{matrix}$$

where Ce is the doping in the emitter (i.e., in the source/drain), βₚ is a recombination current factor (fit parameter), and we have introduced an injection factor, ηₚ, instead of γₚ, where in ideal pn-junction theory

$${η}_{p} = \sqrt{\frac{{D}_{p}}{{τ}_{p}}} ,$$

Dp and τₚ are the minority carrier diffusivity and lifetime respectively.

A further extension of the model adds terms to describe the currents in the space charge regions (displacement-, recombination-, and generation currents). When the displacement and generation currents are added the model (for an nmos source or drain) has the following form:

$$\begin{matrix}n = \frac{{n}_{0} {p}_{0} ( {N}_{D} - {N}_{A} )}{2 {n}_{i}^{2}} ( {( 1.0 + \frac{2 {n}_{i}^{2}}{{γ ( {N}_{D} - {N}_{A} )}^{2}} {e}^{( - \frac{{qV}_{SB}}{{k}_{B} T} )} )}^{γ} - 1.0 ) , & ( 12 ) \\ {J}_{p} = q {η}_{p} ( \frac{{n}_{0} {p}_{0} \vert {C}_{e} \vert}{2 {n}_{i}^{2}} ( {( 1.0 + \frac{2 {n}_{i}^{2}}{{γ ( {C}_{e} )}^{2}} {e}^{( - \frac{{qV}_{SB}}{{k}_{B} T} )} )}^{γ} - 1.0 ) - 1.0 ) - {q}_{0} W ( R - G ) + {κ}_{d} {q}_{0} \frac{ɛ}{W} \frac{d {V}_{appl}}{d t} , & ( 13 ) \\ p = n - ( {N}_{D} - {N}_{A} ) & ( 14 ) \\ {J}_{tot} = {J}_{n} + {J}_{p} + {C}_{j} \frac{d {V}_{SB}}{d t} , & ( 15 )\end{matrix}$$

### Where

$$W = \sqrt{\frac{2 ɛ}{{N}_{D , A}}} \sqrt{{V}_{bi} - {V}_{appl} - \frac{2 {k}_{B} T}{{q}_{0}}} , \qquad ( 16 )$$

The model for a p-type emitter (p-mos) is derived in an equivalent manner.

The recombination current in the space charge region can be added in an equivalent manner, and the details of the functional dependence of these terms can be refined. We do not show all variants explicitly here.

The bulk node of the compact model is also coupled to the substrate via the electrostatic potential.

The numerical mesh in the substrate will need to resolve the separate source and drain (S/D) areas, but does not need to resolve the S/D junctions, junction extensions, or channel area. Beyond the S/D area the mesh in the substrate is dictated by the substrate effects to be simulated, e.g., for an SET the mesh should resolve the SET trace across the substrate. Note that the bulk node of the compact model can simply be attached to a substrate mesh-point in the vicinity of the gate, which could, or could not, be the same as the source or drain mesh-points, depending on the particular substrate phenomenon being simulated (the substrate mesh-points are all in the substrate and reflect the substrate potential).

The core of the invention is that the substrate and the compact model of the circuit are coupled directly, and that the device (MOSFET) operation itself is simulated using a compact model, while all substrate effects (interactions via the substrate) are simulated with a physics based model. To achieve this new boundary conductions are required, we show above where they can be applied and their basic form. However, the BC's can be refined over equations (1)-(16) and calibrated and they could have a different form.

The basic concept of coupling the circuit models directly to the substrate via special boundary conditions, which is the core of this invention, can be extended to circuits using device other than MOSFETs, e.g. bipolar transistors and diodes. Application of the principles leading to the basic equations (1)-(7), will allow extension of the invented method to all types of semiconductor devices and to all phenomena where the internal operation of the circuit devices can be separated from the description/effects of the phenomenon itself.

I claim:

1. A method to model complicated substrate effects at the circuit level in an electronic design automation hierarchy, using a coupling of physics based device simulation(technology CAD - TCAD) and compact model based circuit simulation, said method coupling the simulation of carrier transport in the substrate directly to compact models of circuit devices via boundary conditions, and said method comprising:
a. a first step of determining, based on an electronic circuit layout, a substrate region to be simulated and determining the surface regions, of this substrate regions, which shall be coupled directly to a circuit netlist, said surface regions being such that internal device characteristics of the devices in the electronic circuit can be modeled using compact ODE (ordinary differential equation) models, as used in regular circuit modeling, and that properties of the substrate, in which these devices exist, can be modeled using partial differential equations (PDEs) in the substrate, which appropriately describe the physical mechanisms relevant to the problem, and such that some, or all, of the devices in the circuit net-list can be coupled to the substrate with coupling ODEs at the surface regions, said coupling ODEs accurately describing the interaction between device and substrate and correctly separating the effects which are simulated by the compact ODE models of the device and the PDEs of the substrate; and
b. a second step of simulating a coupled set of equations for the circuit net-list, the substrate, and the coupling boundary regions, where the equations to be solved are: the PDEs in the substrate (discretized on a numerical mesh in the substrate), the compact ODEs describing the behavior of each device, and other coupling ODEs describing the coupling of the substrate and device equations at the coupling boundary regions.

2. A simulation method according to claim 1, where the devices are insulated gate type devices, such as the MOSFET device, and the compact ODE models for these devices can be any models which are provided for various semiconductor technologies (such as BSIM3, BSIM4), and where the coupling boundary regions correspond to the source, drain and gate regions of the devices as given by the layout of the electronic circuit in such a way that they closely, or approximately, match the regions of the source pn-junction, the drain pn-junction, and the area under the gate region, respectively, and where the substrate is the semiconductor substrate with certain doping information such as well and substrate doping, and, furthermore, where the PDE's in the substrate describe the transport of charge and the electric field in the substrate with appropriate models, and where the coupling ODEs, applied on the coupling boundary regions, are such that they correctly separate the device effects simulated by the device compact models and the charge transport simulated by the PDE's in the substrate, and said coupling ODEs, for the source and drain boundary regions, are expressions which relate the minority and the majority carrier concentrations and currents to each other, to the voltage and electric current of the circuit node of the compact model that is coupled to the boundary region, to the electrostatic potential in the substrate on the boundary region, and to various parameters that pertain to the physical models and the structure, and said coupling ODEs, for the gate region, consist of applying the electric potential in the gate contact region of the substrate (or an average over the gate region) to the substrate node of the contact model, along with Neumann conditions for the charge currents in the substrate, or a variant of this model which adds the currents through the insulating gate oxide in the MOSFET gate to the current of the compact device node.

3. A simulation method according to claim 1, where the devices are bipolar devices (e.g., diodes and transistors), and the compact models for these devices can be any models which are provided for various semiconductor technologies (e.g. Gummel-Poon VBIC, MEXTRAM), where the coupling boundary regions correspond to the collector pn-junction region, and gate contact region as given by the layout of the electronic circuit, and where the substrate is the semiconductor substrate with certain doping information, and, furthermore, where the PDE's in the substrate describe the transport of charge and the electric field in the substrate with appropriate models, and where the coupling ODEs are such that they correctly separates the device effects simulated by the device compact models and the charge transport simulated by the PDE's in the substrate.

4. A simulation method according to claims 2 or 3, which uses compact models which includes the temperature and where the PDE's in the substrate are amended by PDE equations for the temperature distribution in the substrate, and where the coupling equation set the compact model temperature equal to the temperature in the coupling boundary regions of the substrate (or an average of the temperature in these regions) and adds a heat flux from the device to the substrate from the heating generated by the currents and voltages in the device.

5 . A simulation method according to claim 4 applied to the simulation of single event radiation effects in an electronic circuit, by repeatedly injecting charge, corresponding to the single event, into the substrate and simulating the effect on the circuit, while varying various parameters such as position, and direction of the of the charge injection, layout, circuit, and substrate properties, for the purpose of determining the precise sensitivity of the circuit to various types of radiation, and for the purpose of determining the circuit and layout configuration that is least sensitive to the single event radiation, hence optimizing the circuit and/or layout w.r.t. its' radiation hardness

6. A simulation method according to claim 4, applied to the simulation of device heating in an electronic circuit, by repeatedly simulating the circuit behavior, while varying various parameters such as bias conditions, layout, circuit, and substrate properties, in order to improve the thermal properties and heat generation in the circuit.

7. A simulation method according to claim 4, applied to the simulation of electrostatic discharge (ESD) in an electronic circuit, by repeatedly simulating the circuit behavior, while varying various parameters such as bias conditions, ESD current pulse, layout, circuit, and substrate properties, in order to improve the ESD properties of the circuit.

8. A simulation method according to claim 1, applied to the simulation of substrate noise in an electronic circuit, by repeatedly simulating the circuit behavior, while varying various parameters such as bias conditions, layout, circuit, and substrate properties, in order to improve the substrate noise properties of the circuit.
